(19) United States
(12) Patent Application Publication
(10) Pub. No.: US 2019/0082236 A1
(43) Pub. Date: Mar. 14, 2019

(54) Determining Representative Content to be Used in Representing a Video

(71) Applicant: The Provost, Fellows, Foundation Scholars, and the other members of Board, of the College of the, Dublin (IE)

(72) Inventors: Fahim A. Salim, Dublin (IE); Owen Conlan, Dublin (IE)

(73) Assignee: The Provost, Fellows, Foundation Scholars, and the other members of Board, of the College of the, Dublin (IE)

(21) Appl. No.: 16/127,982

(22) Filed: Sep. 11, 2018

(30) Foreign Application Priority Data
Sep. 11, 2017 (GB) 1714592.1

(51) Int. Cl. H04N 21/845; H04N 21/6587; H04N 21/258; H04N 21/475

(52) U.S. Cl. CPC H04N 21/8456; H04N 21/4755; H04N 21/25891; H04N 21/6587

(57) ABSTRACT

A computer implemented method provides determining representative content to be used in representing a video divided into one or more segments. Each segment is associated with one or more items of representative content data for use in representing that respective segment. The one or more items of representative content data have an associated modality. The method comprises, for each segment, selecting, based on one or more rules depending on one or more selection factors, a respective optimized template from a set comprising one or more templates, each one of the set of templates defining a different representation setting for representing the segment using its associated representative content data, the representation settings specifying the modality of representative content data to be used in representing a segment. The method also comprises determining representative content data for each of the one or more segments based on the respective optimized template for each segment.

This application relates to a computer implemented method of determining representative content to be used in representing a video, a data processing apparatus comprising one or more processors adapted to perform the method and a computer readable storage medium comprising instructions which, when executed by a computer, cause the computer to carry out the method.

Exploring a video is typically time consuming and inefficient. This is due to the linear streamed nature of video media. In order to find a particular piece of information within a video, a user will often need to manually search through the entire length of the video by starting playback at different points in the video until the desired content is found. In this example, the user may have to guess the position of content within the video, or try to recall the approximate time at which the desired content appeared (e.g. half way through the video) if they have already viewed the video before. This may be time consuming for the user and require additional burden on computing resources required to access, buffer and display multiple different parts of the video until the user has found what they are searching for.

Video is a versatile form of content in terms of multimodality. By multimodality we mean that videos are composed of a set of features, namely the moving video track, the audio track and other derived features, such as a transcription of the spoken words. Together these modalities can give a very effective way of communicating information. The content value of these modalities as a whole exceeds their value separately. But richness (both in terms of modalities and amount available) of video content creates challenges. Videos can vary in length and can be several hours in length. It may be difficult for a user to fully view every piece of video which could be useful or important for them as this is time consuming as described above. Thus there is a need for more effective means to explore video content so that the user can find the desired content as quickly and conveniently as possible, rather requiring different parts of the video to be accessed and displayed multiple times by a computing system, thus wasting computer resources.

Prior art technologies almost solely rely on textual information such as metadata or transcripts etc. While individual segments within a video can be searched and referenced, e.g. by URL, it is still inefficient to quickly get an idea of all the available content to consume only that which is desired. Prior art examples do not fully harness the multimodal potential of video content. In the prior art, video exploration is approached by enhancing video selection capability from a large collection, either by listing search query results based on indexing of multimodal attributes or by listing video recommendations. However, once a short list of videos is identified or even when users have a single video to begin with, the process of getting the desired information from within the video or assessing if the video is interesting or not is still inefficient. To solve this problem, prior art technologies include video navigation, hyper videos, or video summarisation. These examples however have limitations in efficiently providing the information the user is looking for.

Current techniques allow users to explore the content within a video either by providing the ability to search for something particular or by giving an overall synopsis of the video, e.g. video synopsis. In video summarisation, importance is usually attributed to visual features. Searching for a piece of information within video assets is still often text based for commercial examples such as YouTube. Work has however been done on multimodal methods to extract information from videos. These include face recognition along with name tags to find footage of certain people, text recognition to see if there is any textual information appearing in videos and searching using metadata attributes.

Overall, with the use of key frames and/or other textual information, such as keywords, prior art approaches allow the user to search a particular item and jump to a particular position in the video, but lack the ability to give an overall synopsis. In this case, a user may have to perform multiple searches or view multiple different parts of the video in order to find the information they are looking for. This may put undue burden on computer resources required to provide multiple searches and access, buffer and display multiple different parts of the video until the user has found what they are looking for. Current video summarisation techniques may help provide the overall synopsis of the video, but the ability to get something particular in limited by the overall visual focus of the representation.

An objective of the present application is to provide an improved method of determining representative content which can be used to efficiently represent a video. In one aspect, the present invention provides a computer implemented method of determining representative content to be used in representing a video, the video being divided into one or more segments, each segment being associated with one or more items of representative content data for use in representing that respective segment, the method comprising: determining representative content data for each of the one or more segments by selecting an optimised template for each segment from a set of templates, each one of the set of templates defining a different representation setting for representing the segment using its associated representative content data.

By determining representative content data for each segment of the video by selecting an optimised template the method allows the representative content data to be chosen to represent the video in advantageous combinations and in a configurable manner. This may allow deeper and more effective content exploration within the video. This may provide a more efficient method of finding desired content within a video compared to a user manually searching through the entire length of the video.

The method of determining representative content may be used as part of a method of searching for information within a video. By determining optimised representative content data for use in representing the video, the user may more quickly find the information they are looking for, without the need for scrolling through the entire video or repeatedly entering different search terms until desired information is found. This may reduce the number of times a server storing the video is accessed to display different parts of the video. It may also reduce the number of times a server implementing a search algorithm is accessed to perform repeated searches until the user finds what they are looking. The method of this application may therefore reduce bandwidth and computing burden.

Optionally, the one or more items of representative content data may have an associated modality, and wherein the representation settings defined by the templates specify the modality of representative content data to be used in representing a segment. By taking the modality into account the selection of the templates can be optimised.

Optionally, the representation settings defined by the templates may specify the number of different modalities of representative content data to be used in representing a segment. This may allow an optimised mixture of different modalities to be selected to represent some segments, or a single modality to be used for other segments.

Optionally, the representation settings defined by each of the templates may specify a combination of different modalities of representative content data to be used in representing a segment. This may allow an optimised specific combination of modalities to be determined.

Optionally, the one or more items of representative content data may have an associated expanse value, and wherein the representation settings defined by the templates may indicate the expanse value of representative content data to be used in representing a segment. By taking the expanse of content data into account the selection of the templates can be optimised.

Optionally, selecting an optimised template may comprise selecting a template based at least partly on a relevance factor determined based on a current information need of an entity to which the video is to be provided. This may allow the selection of a template to be optimised based on the relevance of a video segment to an entity requesting information.

Optionally, the method may further comprise: receiving a request for information; and determining the relevance factor of each of the one or more segments of the video to the request for information, wherein the template may be selected based at least partly on the relevance factor. The may allow the optimised selection of the template according to the relevance of a video segment to an entity requesting information. This may allow suitable (e.g. more detailed) information to be determined to represent more relevant segments of the video.

Optionally, the one or more items of representative content data may have an associated modality, and wherein the template is selected based at least partly on a relationship between the relevance factor of the respective segment and the modality of the associated representative content data for that segment. This may allow the modality of the items of representative content data to be optimised according to the relevance of a segment of the video.

Optionally, the relationship comprises: selecting a template such that the number of modalities of content specified by the template is proportional to the degree of relevance of the segment. This may allow a greater number of different modalities to be used to represent video segments having a greater relevance.

Optionally, selecting an optimised template may comprise selecting a template specifying a single modality for a segment having a first relevance factor and selecting a template specifying a mixture of modalities for another segment having a different second relevance factor, and optionally wherein the first relevance factor indicates a lower degree of relevance of the respective segment compared to the second relevance factor. This may allow single modality representative content data to be used to represent a less relevant segment compared to a mixture of different modality representative content data to be used for a more relevant video segment.

Optionally, the one or more items of representative content data may have an associated expanse value, and wherein the template may be selected based at least partly on a relationship between the relevance factor of the respective segment and the expanse value of the associated representative content data for that segment. This may allow the expanse of the items of representative content data to be optimised according to the relevance of a segment of the video.

Optionally, the relationship comprises: selecting a template such that the expanse value of content specified by the template is proportional to the degree of relevance of the segment. This may allow representative content data having a greater expanse (e.g. providing a deeper level of information) to be determined to represent more relevant segments of the video.

Optionally, selecting an optimised template comprises: selecting a template specifying a first expanse value for a segment having a first relevance factor and selecting a template specifying a second expanse value for another segment having a different second relevance factor, wherein optionally the first relevance factor indicates a lower degree of relevance compared to the second relevance factor, and the first expanse value indicates a lower degree of expanse compared to the second expanse value. This may allow representative content data having a low expanse value to be used for less relevant segments of the video compared to representative content data having a higher expanse value being used for segments having a high relevance.

Optionally, the template may be selected based at least partly on a user preference, wherein the user preference defines one or more preferred properties of content for a specific user. This may allow the template selection to be optimised based on the representative content data preferred by the user. This may improve the efficiency of the template selection by narrowing the choice of templates from the set of templates that can be chosen for a video segment.

Optionally, the one or more items of representative content data have an associated modality, and wherein the template may be selected based at least partly on a relationship between the user preference and the modality of the representative content data. This may allow the user to specify a preferred modality they wish to be used to represent segments of the video.

Optionally, the relationship comprises: selecting a template having a representation setting defining a modality of the representative content data matching the user preference. This may allow the template selection to be optimised according to the user's (or other relevant entity) preference.

Optionally, the one or more items of representative content data have an associated expanse value, and wherein the template is selected based at least partly on a relationship between the user preference and the expanse value of the representative content data. This may allow the user to specify a preferred expanse they wish to be used to represent segments of the video.

Optionally, the relationship comprises: selecting a template having a representation setting defining an expanse of representative content data matching the user preference. This may allow the template selection to be optimised according to the user's (or other relevant entity) preference.

Optionally, the template is selected based at least partly on the availability of representative content data for a segment. This may further improve the efficiency of the template selection by narrowing the choice of templates from the set of templates that can be chosen for a video segment.

Optionally, the one or more items of representative content data have an associated modality, and wherein selecting the template may comprise selecting a template having a representation setting defining a modality of associated representative content which is available for the respective segment. This may narrow the choice of templates to only those that specify available representative content data for a segment.

Optionally, the one or more items of representative content data have an associated expanse value and wherein selecting the template may comprise selecting a template having a representation setting defining an expanse value of associated representative content which is available for the respective segment. This may narrow the choice of templates to only those that specify available representative content data for a segment.

Optionally, the template may be selected from a template store comprising a plurality of predefined templates each having different representation settings. This may allow different representative content data to be efficiently chosen to represent each segment of the video.

Optionally, the representative content data has one or more modalities chosen from: visual modality, paralinguistic modality, linguistic modality, video modality or supplementary information.

Optionally, the method may comprise generating representative content data for each segment of the video.

Optionally, the method may further comprise associating the representative content data with one or more timestamps indicating a relative position within the timespan of the video. This may allow the representative content data to be stored such that the relevant representative content data for a video segment can be efficiently accessed.

Optionally, the method may comprise storing the generated representative content data and associated timestamps in a data repository. This may allow the representative content data to be available for use in the method.

Optionally, the method may further comprise segmenting the video into the one or more segments. This may allow the video segments to be available for use in the method.

Optionally, the video is segmented based on a genre of the video. This may allow the segmentation to be optimised based on the content or information in the video.

In a second aspect, the present disclosure provides a data processing apparatus comprising one or more processors adapted to perform the method of the first aspect.

In a third aspect, the present disclosure provides a computer readable storage medium comprising instructions which, when executed by a computer, cause the computer to carry out the method of the first aspect.

Embodiments of the invention will now be described, by way of example only, with reference to the accompanying drawings, in which:

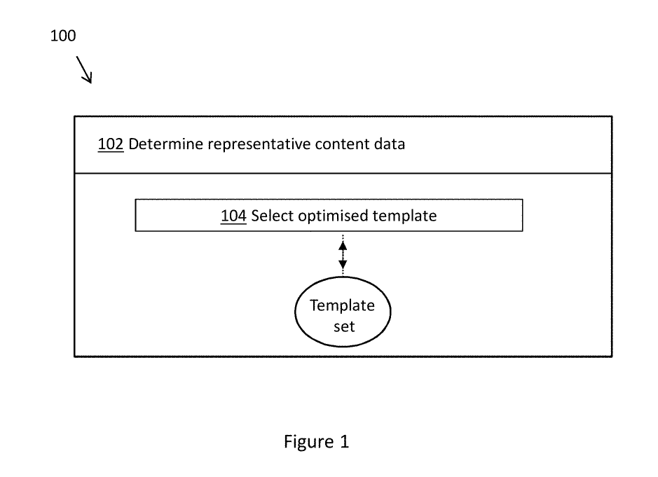

FIG. 1 shows a computer implemented method of determining representative content according to an embodiment;

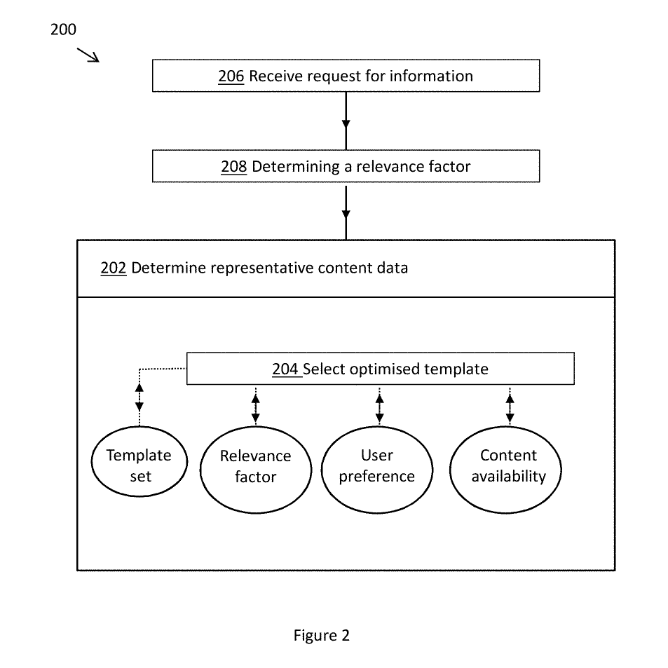

FIG. 2 shows a computer implemented method of determining representative content according to an embodiment;

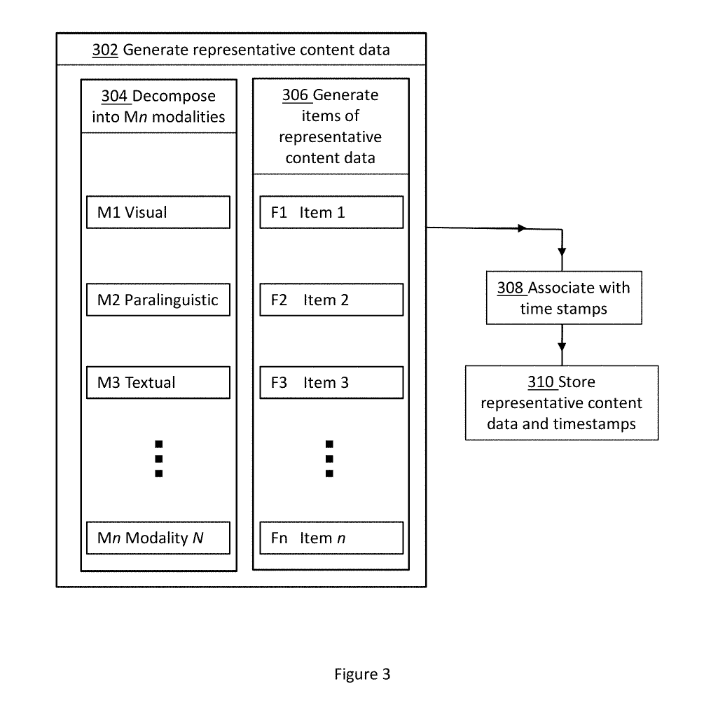

FIG. 3 shows a method of generating representative content data;

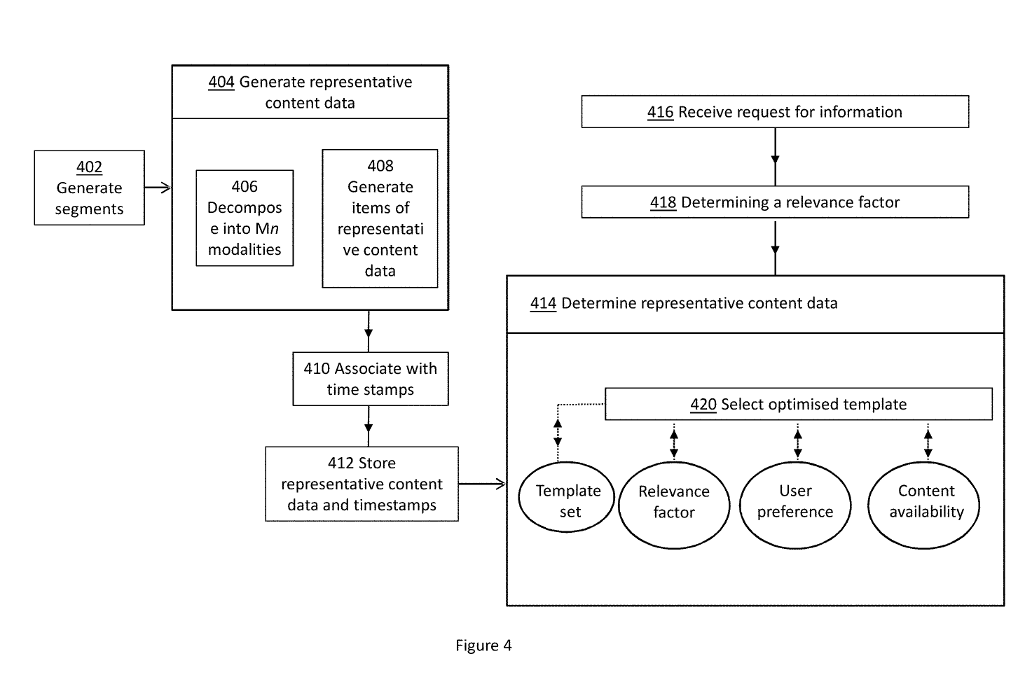

FIG. 4 shows a computer implemented method of determining representative content according to an embodiment; and

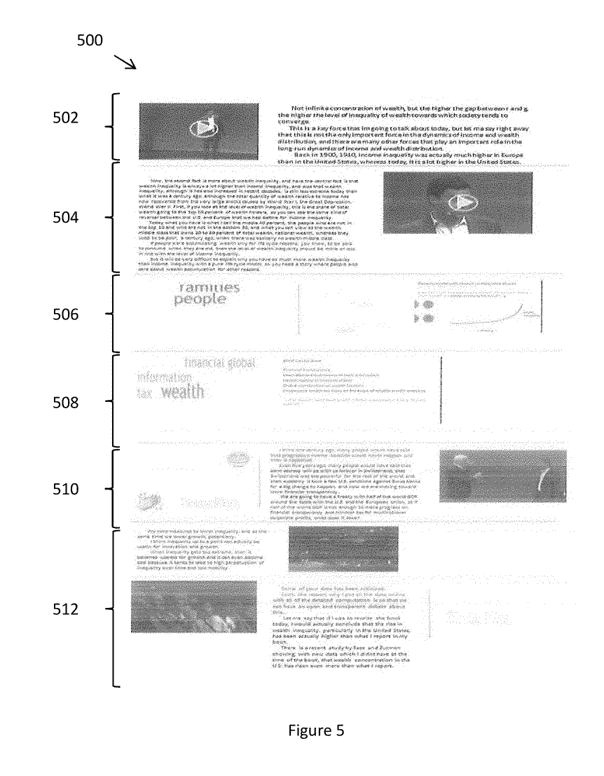

FIG. 5 shows a representation of a video provided by the method of an embodiment.

A computer implemented method 100 of determining representative content to be used in representing a video according to an embodiment is shown schematically in FIG. 1.

The video for which representative content is to be determined is divided into one or more segments. Each segment may correspond to a portion of the overall length of the video. In some embodiments, the segments may vary in length and together may represent only part of the overall video. In other embodiments, the entire length of the video may be formed into segments. For example, in some embodiments, the entire video may be formed into continuous segments of equal duration. For efficient exploration, the user may need to focus more on some segments and less on others. Therefore, it is important that the video is divided into reasonable segments. In some embodiments, the choice of segment length and/or segment position within the video may depend on different factors e.g. the genre of the video, as will be described later. The video segments may be pre-generated for use in the method 100, or may be generated as part of the method 100 as will be described later.

In the described embodiment, each one of the video segments is associated with one or more items of representative content data. The representative content data may be data that is used in representing each segment of the video segment to the user. The representative content data may be obtained from a local data store or received from a networked data source. The representative content data may be associated with the one or more segments of the video using, for example, timestamps or tags to show which data relate to which segments of the video. The representative content data may be pre-generated and stored in an appropriate data store for use in the method 100, or may be generated as part of the method 100 as will be described later.

The representative content data may comprise any representative data that relate to the content of the video and can be used to represent information contained in or related to video. For example, the data may comprise data directly extracted from the video itself, e.g. a screen shot, an audio sample, or a portion of the video itself, etc. It may additionally or alternatively comprise data that are derived from the video, e.g. a human written or computer generated text summary or description of the video, a transcript of the spoken words contained with the audio track of the video (either human generated or automatically parsed from the video), or other meta data associated with the video. The representative content data may therefore be used to represent the information conveyed or contained in the video to a user or other entity—it may however include data apart from the image and audio data forming the video itself.

As can be seen in FIG. 1, the method 100 comprises determining 102 representative content data for each of the one or more video segments by selecting an optimised template for each segment from a set of templates. Each one of the set of templates defines a different representation setting for representing the segment using its associated representative content data. Once selected, a template may therefore provide instructions for choosing the required representative content data to be used to represent each segment of the video. The template for a segment may be obtained from a local data store in which the set of templates are stored, or may be obtained from a remote data store over a network. In some embodiments, the set of templates may be pre-generated and can be used for a range of different videos and video segments. In other embodiments, the templates may be generated as part of the method 100 as will be described later.

In the described embodiment, the set of templates comprises a plurality of different templates each having different representation settings. In other embodiments, the set of templates may comprise a single template. By selecting a template from a set of templates, each specifying which representative content data is to be used for a segment, the method allows flexible and configurable content to be intelligently chosen to represent the video. This provides an improved method of representing the content of the video. It may, for example, allow a more efficient method of finding desired content within a video compared to manually searching through the entire length of the video until the desired information has been found. By providing an improved method of determining the content used to represent the video, the method 100 may reduce the burden on computing resources required to repeatedly access, render and display different parts of the video until the desired information or section of the video is found.

The representation settings defined by each of the templates may specify one or more characteristics of the representative content data to be used for a segment. This may allow the templates to specify which items of representative content are to be used to represent a particular segment of the video. When rendering each segment of the video, appropriate items of representative content can therefore be chosen from those associated with a particular segment. This allows a flexible and configurable rendering of the segments of the video, where the representative content used for each segment can be intelligently controlled and optimised.

In the described embodiment, the characteristics of the representative content data include the modality, relevance and feature type as described below. In other embodiments, one or more of these characteristics may not be used. In yet other embodiments, the representative content data may have other associated characteristics.

In the described embodiment, the one or more items of representative content data may have an associated modality. By modality we mean a particular way in which information is encoded for presentation to a user. In this embodiment, the representation settings defined by each of the templates may specify the modality of representative content data to be used in representing a segment. This allows the templates to specify the mode of representative content data to be chosen from the data associated with a particular segment for use in representing that segment.

The representative content data may be categorised as having one or more modalities chosen from, for example:

i) Visual mode

ii) Audio (paralinguistic) mode

iii) Linguistic (textual) mode

iv) Video mode

v) Supplementary information e.g. information that may accompany a video or provide further information about it (e.g. slides associated with a presentation video, database information (e.g. for movies) etc).

In some embodiments, the video mode may be considered to be a distinct modality or in other embodiments may be considered to be content having visual, audio and linguistic modes.

The representation settings may specify the modality of representative content data to be used to represent a segment of the video.

In some embodiments, the representation settings may specify the number of different modalities of representative content data to be used in representing a segment. In the described embodiment, the representation settings may specify whether a single modality or a mixture of different modality representative content data is to be used for representing a segment.

In other embodiments, the representation settings may specify a numerical value for the number of modalities e.g. that representative content data has a single mode, two different modes, three different modes, etc.

In the described embodiment, where a single modality is specified, the representation settings may specify a particular modality. In other embodiments, where representative content data having a single modality is specified, the representation settings may also specify the number of separate items of representative content data that are to be used for that segment. For example, the representation settings may specify that two items of representation content data having a visual modality are to be used to represent a segment.

Where representative content data having a mixture of modes (or a particular number of two or more different modes) is specified, the representation settings may further specify the number of separate items of representative content data are to be used and the number of modalities each item of content data should have. For example, one or more separate items of content data may be specified, each having two or more different modalities. For example, a single item of content data may be specified, having both visual and semantic modality. Additionally or alternatively, one or more separate items of content data may be specified each having a single modality such that the overall number of modalities equals a total number specified by the representation setting. For example, three separate content items may be specified, which overall have two different modalities (e.g. two are the same modality, the third being a different modality).

In some embodiments, the representation settings defined by each of the templates may specify a particular combination of different modalities of representative content data to be used in representing a segment—e.g. the representation settings may specify that both visual modality and semantic modality representative content data is to be used for a segment.

In the described embodiment, each template may define a primary modality of representative content data that is to be used for a segment. In some embodiments, each template may define a secondary, tertiary etc modality or mixture of modalities that may be used for a segment.

In some embodiments, the one or more items of representative content data may have an associated expanse value. The expanse value is related to the detail of content that is provided to the user. For example, some representative content data may have a deeper expanse in terms of information value it provides (and so have a high expanse value), while others may offer less detailed content to the user (and so have a low expanse value). Less detailed features may however be more efficient to consume in terms of time. It is therefore important to use representative content data having an optimized expanse value.

For example, consider the actual video footage of a particular segment. It would offer the full content of that segment (and so has a high expanse value) but it will require longer to view compared to an automatic text summary (having a low expanse value) generated from the segment transcript. The text summary would require less time for the user to consume but its expanse in terms of content value would be limited compared to the video footage. Similarly, consider key frames from the video footage or a word cloud of key terms from textual transcript. Both will be efficient in terms of time but limited in terms of depth of information. By taking the expanse value into account, the method may optimize the determination of representative content used for a segment.

The representation settings defined by the templates may indicate the expanse value of representative content data to be used in representing a segment. In one embodiment, the expanse value may be quantified by a Boolean variable indicating whether the representative content data has a high level of expanse (the expanse value=“deep”) or whether the representative content data has a low level of expanse (the expanse value=“efficient”). A “Deep” level of expanse may mean that high level of detail of information is provided by the representative content data (e.g. a text summary) compared to an “Efficient” level of expanse which may mean the information has less detail, but can be quickly taken in by the user (e.g. keywords). In some embodiments, the expanse value may be assigned based on subjective classification based on user judgement. In other embodiments, an expanse value may be assigned by a tool used to generate the representative content data. In other embodiments, it can also be dependent upon the semantic value or semantic variation within a segment.

The representation settings may further specify the feature type of representative content data that is to be used to represent a segment of the video. The feature type may correspond to the specific type of feature that is to be used to represent the segment and may include data extracted from the video data itself (e.g. video segments, audio) or may be other data derived or otherwise generated from the information contained in the video (e.g. word clouds, human generated summaries). The feature types and number of different feature types may depend on the format or genre of the video. In one embodiment, examples of feature types include: words clouds, key frames, text summaries, video portions, the video segment itself, and any other features types that may be generated or otherwise extracted.

An example of the representation settings defined by a set of templates according to the described embodiment is given in the following table:

| Template | | Primary | |
|---|---|---|---|
| ID | Expanse | Modality | Feature(s) Type |
| 1 | Efficient | Textual | Word Cloud |
| 2 | Efficient | Visual | Key Frames |
| 3 | Deep | Textual | Text summary |
| 4 | Deep | Visual | Video Snippet |
| 5 | Deep | Textual | Word Cloud, Text Summary |
| 6 | Deep | Visual | Key frames, Video snippet |
| 7 | Deep | Mixture | Key frames, text summary |
| 8 | Deep | Mixture | Word Cloud, Video snippet |
| . | | | |
| . | | | |
| . | | | |
| N | Deep/ | Single/Mixture | Any other permutation of |
| | Efficient | | extracted features. |

The number of templates may be dependent upon the representative content data available for a video (for example, the number of templates may increase if there are a large number of different feature types). As can be seen in the table above, a template may define a possible permutation of available feature types. In some embodiments, not all the permutations are included in the set of templates (e.g. only those which provide an advantageous representation of information may be included). In other embodiments, all permutations of combinations of representation settings may be included in the template set.

Selecting the optimised template may comprise selecting a template from the set of templates using one or more different selection factors. An embodiment of a method 200 of determining representative content to be used in representing a video in which the template is selected based on three selection factors—a relevance factor, user preference and content availability—is shown in FIG. 2. This is however only one such example, in other embodiments the templates may be selected based on any other combination of factors, or based on a single factor. The selection factors may relate to the properties of a particular segment (e.g. the availability of content for that segment) or may relate to other factors (e.g. to the user).

The relationship between a selection factor used to select a template and the template selected for a segment may be determined by one or more selection rules. The selection rules may therefore govern how a particular selection factor is taken into account when selecting a template. They may, for example, define a value or range of values for a particular selection factor and the resulting properties of template that should be selected for a segment. A template may be selected from the set of templates automatically according to the one or more selection factors and selection rules. Further details of the selection factors and selection rules are described in the following.

The embodiment shown in FIG. 2 comprises steps of determining 202 representative content data and selecting 204 an optimised template corresponding to those of the embodiment shown in FIG. 1 described above.

In the embodiment shown in FIG. 2, the template may be selected 204 based on the relevance of a video segment to a user (or other agent). The relevance of a segment may be quantified by a relevance factor which may be determined 208 by one or more different relevance determining factors.

In the described embodiment, the relevance factor may be determined based at least partly on the current information need of an entity to which the video is to be provided. In the described embodiment, the current information need may be determined at least partly on a request for information. In this embodiment, the method 200 comprises a step of receiving 206 a request for information. This may be a search request from a user (e.g. a search query term entered into a search engine), or a search request received from other software or other agent. The request for information may take the form of an input search query formed by one or more search terms. In other embodiments, any other suitable method of providing a request for information may be used e.g. an image or voice input may be provided.

In some embodiments, the current information need may additionally or alternatively be defined by other information such as the time, location or the type of device initiating a request for information. In other embodiments, the current information need may be determined by other request metadata such as the device from which the request for information is received and time it was made etc. This may help determine modality preference e.g. heavy visual information may be not be suitable for a device such as a those having a small screen such as a mobile device (e.g. a smart phone or the like).

In some embodiments, the current information need may additionally or alternatively be found based on user preference data. In this embodiment, a match may be found between personal preference data indicating topics that the user may find interesting and the topic of a segment. For example, even if a video segment may not contain the information required by the current query request it might have info which might be of interest. This may be particularly important in embodiments were the relevance factor of a segment is found without receiving a request for information from an entity. This may allow video segments to be provided for efficient browsing of information, without requiring a specific request for information to be provided.

In yet other embodiments, the relevance may be determined based on the segments preceding and/or following a respective segment. In this embodiment, the narrative content of the preceding or following segments may be used to determine the relevance. For example, the surrounding segments may have some impact on the narrative of the segment in question and so can be taken into account when finding the relevance.

Once the search request has been received 206, the method may further comprise determining 208 a relevance factor of each of the one or more segments according to any of the factors described above. In other embodiments, the step of receiving a request for information (step 206 shown in FIG. 2) may be omitted and the relevance factor may be determined based on factors which do not require a request for information.

In some embodiments, the relevance between the request for information and a segment of the video may be determined 208 by calculating a relevance function. The relevance function may take as inputs a video segment and one or more of the relevance determining factors (e.g. those described above) and return a relevance factor for that segment. In one embodiment, the relevance function may be given by:

Segment_Relevance=getRelevance(seg,Pseg,Fseg,pm,co).

### Where:

Seg is the segment in question
Pseg is the segment preceding the segment
Fseg is the segment following the segment
pm is the personalization model
co is the request context and may comprise the query for information i.e. the current information request as described above.

In one embodiment, the relevance factor (e.g. Segment_Relevance in the above example) may be a Boolean variable indicating whether the segment is relevant to the request for information (the relevance factor=“relevant”) or whether the segment is not relevant to the request for information (the relevance factor=“not relevant”). This may provide a simple and efficient selection of the template. In other embodiments, other values for the relevance factor may be used. In some embodiments, for example, the relevance factor may be an overloaded version of the Boolean example above and may return more than binary values for relevance. In other examples, the relevance factor may be a continuous numerical scale (e.g. running from zero representing not relevant to 100 representing relevant).

Once a relevance factor for a segment has been determined 208, a template may be selected 204 for that segment base at least partly on that relevance factor.

In embodiments where the one or more items of representative content data have an associated modality, a template may be selected 204 based at least partly on a relationship between the relevance factor of the respective segment and the modality of the associated representative content data for that segment. This may allow representative content data to be intelligently chosen having a modality optimised for the relevance of the information.

In this embodiment, the selection rules used to select a template define the template to be selected according to the relevance factor of a segment.

In some embodiments, selecting an optimised template 204 may comprise selecting a template such that the number of modalities of content is proportional to the degree of relevance of the segment (e.g. a greater number of modalities are selected for a segment of greater relevance). In the described embodiment, selecting an optimised template comprises selecting a template specifying a single modality for a segment having a first relevance factor and selecting a template specifying a mixture of modalities for another segment having a different second relevance factor. The first relevance factor may indicate a lower degree of relevance compared to the second relevance factor. This may allow more detailed content in a variety of different modalities to be used to represent segments which are more relevant to an entity requesting information.

In some embodiments, the relevance factor may define a number of discrete varying degrees of relevance. For example, in embodiments where the relevance factor may take one of the Boolean values of “relevant” and “not relevant”, a template specifying a single modality of content may be selected for a segment having a “not relevant” relevance factor. A template specifying a mixture of modalities may be selected for a segment having a “relevant” relevance factor.

In other embodiments, the relevance factor may take more than two different discrete values or may be quantified as a range of numerical values. In this embodiment, selecting a template may comprise selecting a template having a representation setting defining a single modality of representative content data for a segment having a relevance factor less than a predefined threshold. Alternatively, for a segment having a relevance factor greater than a predefined threshold, selecting a template may comprise selecting a template having a representation setting specifying a mixture of different modalities of representative content data.

In embodiments where the one or more items of representative content data have an associated expanse value, the template may be selected 204 based at least partly on a relationship between the relevance factor of the respective segment and the expanse value of the associated representative content data for that segment. This may allow representative content data to be intelligently chosen having an expanse optimised for the relevance of the information. For example, for segments that have been determined to be more relevant, items of representative content data having a greater expanse (e.g. detailed content providing in depth information) may be more suitable. An appropriate template may therefore be selected having a representation setting specifying representative content data with high expanse value.

In some embodiments, selecting 204 an optimised template may comprise selecting a template such that the expanse value of content specified by the template is proportional to the degree of relevance of the segment (e.g. content having a greater level of expanse may be selected for a segment of greater relevance). In the described embodiment, selecting 204 an optimised template comprises selecting a template specifying a first expanse value for a segment having a first relevance factor and selecting a template specifying a second expanse value for another segment having a different second relevance factor. The first relevance factor may indicate a lower degree of relevance compared to the second relevance factor, and the first expanse value may indicate a lower degree of expanse compared to the second expanse value. This may further allow more detailed content to be used to represent segments which are more relevant to an entity requesting information.

In some embodiments, the expanse factor may define a number of discrete varying degrees of expanse. For example, in embodiments where the expanse factor may take one of the Boolean values of “Deep” and “Efficient” a template specifying a “Deep” expanse of content may be selected for a segment having a “relevant” relevance factor, and a template specifying an “Efficient” expanse may be selected for a segment having a “not relevant” relevance value.

In other embodiments, the expanse value or the relevance factor may take more than two different discrete values or may be quantified as a range of numerical values. In such embodiments, selecting 204 a template may comprise selecting a template having a representation setting specifying an item of representative content data having an expanse value less than a predetermined threshold for a segment having a relevance factor less than a predefined threshold. Alternatively, selecting 204 a template may comprise selecting a template having a representation setting specifying an item of representative content data having an expanse value greater than a predetermined threshold for a segment having a relevance factor greater than a predefined threshold.

In the embodiment shown in FIG. 2, the template may also be selected 204 based at least partly on a user preference. The user preference may define one or more preferred properties of content for a specific user or other entity to which the video is to be represented. The user preference may comprise predetermined user preference data obtained from a local data store or a remote server as would be apparat to the skilled person.

For embodiments where the one or more items of representative content data have an associated modality, a template may be selected 204 based at least partly on a relationship between the user preference and the modality of the representative content data. In this embodiment, the selection rules used to select a template may comprise selecting a template having a representation setting defining a modality of the representative content data matching the user preference. For example, the user preference may indicate that the user prefers to view content with a text modality because they are fast readers.

For embodiments were the one or more items of representative content data have an associated expanse value, a template may be selected 204 based at least partly on a relationship between the user preference and the expanse value of the representative content data. In this embodiment, the selection rule used to select a template may comprise selecting a template having a representation setting defining an expanse of representative content data matching the user preference. This may allow content having a low expanse (e.g. expanse value=“Efficient” to be provided to users who only wish to see a summary of a video rather than the detailed information it contains.

In the embodiment shown in FIG. 2, the template may be further selected 204 based at least partly on the availability of representative content data for a segment. This may prevent the selected template from specifying unavailable content for a particular segment. For example, it may prevent a template specifying representative content having a textual modality when no representation content data with a textual modality is available. This may help to narrow down the choice of templates for selection, thus improve the efficiency of the template selection.

For example, it is possible that certain features are not present in a particular video. As an example, consider a TED (TED Conferences, LLC) presentation video in which the presenter does not use any slides or any other visual aid. For such a video, the tools designed to extract slides from a video would not return any output hence the keyframes feature for that video would not be available for that video which will affect the choice of potential representations for that video.

In embodiments where the one or more items of representative content data have an associated modality, selecting 204 a template may comprise selecting a template having a representation setting defining a modality of associated representative content that is available for the respective segment. In embodiments where the one or more items of representative content data have an associated expanse value, selecting 204 a template may comprise selecting a template having a representation setting defining an expanse value of associated representative content that is available for the respective segment. This may allow the template to be efficiently selected by quickly narrowing down the choice of available templates according to the availability of representative content data.

In some embodiments, the selection factors used in the selecting 204 an optimised template may be implemented in a predetermined order of priority. For example, in some embodiments, selecting 204 a template may comprise narrowing the choice of templates first based on relevance to a request for information, followed by segment availability, followed by user preference. This may allow an efficient selection of templates from the large number of different templates in the set by progressively narrowing down the choice of template until an optimised template is found.

In one embodiment, selecting a template may be performed according to the following pseudo code:

Preconditions

| 1) | Video has been segmented |
|---|---|
| 2) | items of representative content data are generated and indexed |
| | (e.g. in a data store) |
| 3) | Template set, user preference/personalization model is available |

For each segment do:

Determine if segment is relevant to a given context by relevance
function.
If segment is relevant choose “deep” expanse templates
Else choose “efficient” expanse template
If segment is efficient then choose single modality

Find segment suitability for modality
If only one suitable template is available to choose from the

template set that can represent segment choose that template

Else see user preference
Choose template with user's preferred modality

Else choose mix modality

Choose visually efficient and textually deep or vice

versa based on segment suitability and user preference giving priority to
segment suitability.

As discussed above, a template may be selected 104, 204 from a template store comprising a plurality of predefined templates, each having different representation settings. In some embodiments, the templates may be selected 104, 204 from a pre-generated store of templates that can be used to determine representative content data for a number of different videos, or which may be tailored to a specific type or genre of video.

In other embodiments, the method 100, 200 of determining representative content to be used in representing a video may comprise generating the set of templates. The combination of representation settings defined by each of the templates (e.g. the feature types or combination of features types for specific relevance or expanse factors) may be determined based on user studies providing information on how efficiently users may consume information of various types from a video.

In some embodiments, the representative content data for each segment of the video may be obtained from a data store in which the content data is stored. In some embodiments, one or more videos may be pre-processed in order to generate or obtain representative content data suitable for use in the method 100, 200. This may provide a repository of pre-processed videos that may be accessed by the method 100, 200 to quickly and efficiently determine representative content data.

In other embodiments, the method 100, 200 of determining representative content to be used in representing a video may further comprise generating representative content data for each segment of the video. A method of generating representative content data is shown schematically in the flow chart of shown in FIG. 3. In this embodiment, generating representative content data 302 comprises decomposing 304 each of the video segments into data having Mn different modalities (e.g. visual, paralinguistic, textual as discussed above). The resulting data is then used to generate 306 separate items of representative content data.

The video segments may be decomposed 304 into separate modalities and separate features extracted or otherwise generated from the resulting data using one or more video processing tools known in the art as would be apparent to the skilled person.

For example, in embodiments where, the video is a TED style presentation video the following may be generated from each respective modality of the video:
The visual modality i.e. anything visually interesting or engaging to the viewer, e.g. visual features like camera close up or visual aid, etc.
The paralinguistic modality i.e. the audio features, e.g. laughter, applauses and other audio features.
The linguistic modality, i.e. the spoken words, also any text with in the video as well as any supporting resources e.g. human written synopsis, etc.

Once generated 306, the method may further comprise associating 308 the representative content data with one or more timestamps indicating a relative position within the timespan of the video. Once associated 308 with a suitable timestamp, the method may further comprise storing 310 the generated representative content data and associated timestamps in a data repository. An example of suitable metadata which include a timestamp for a segment stored in the data store is given below:

{

“id”:“ThomasPiketty_2014S-480p_c99_2”,
“video”:[“ThomasPiketty_2014S-480p”],
“num”:[2],
“segmenter”:[“C99”],
“Start_time”:[“00:02:42”],
“End_time”:[“00:07:58”],
“seg_text”:[“\n\tSo there is more going on here, but I'm not

going to talk too much about this today, because I want to focus on
wealth inequality. \nSo let me just show you a very simple indicator
about the income inequality part. \nSo this is the share of total income
going to the top 10 percent........................ ”],

“_version_”:1573803391248760832},

In other embodiments, any other suitable metadata formats or content may be used to store information related to a segment of the video. A similar data structure may be used to store an item of representative content data in a data store. The skilled person will understand that the format of the metadata and format of the storage of the representative content data items may be adapted as required for a specific implementation.

In some embodiments, the video segment may be pre-generated and obtained from a local or remote data storage. In other embodiments, the method 100, 200 may further comprise segmenting the video into the one or more segments. This may allow the segmentation to be tailored for a specific video or representation of information.

In one embodiment, the video may be segmented based on the genre of the video. For example, in embodiments where the video is a TED style informational or infotainment videos, the segmentation algorithm used may be the C99 text algorithm known in the art. In other embodiments, the video may be segmented based on visual segmentation, multimodal segmentation and semantic segmentation techniques as is known in the art.

In some embodiments, the method may take as an input a video and provide as an output the representative content data for representing one or more segments. An example of such a method is shown in FIG. 4. In this embodiment, the method 400 may comprise steps of segmenting the video 402, generating 404 representative content data (comprising steps of decomposing 406 the video segments into Mn modalities and generating 408 items of representative content data along with associating 410 it with a timestamp and storing 412 it) and determining 414 representative content data described above (which in the described embodiment further comprises receiving 416 a request for information and determining 418 a relevance factor). The step of determining representative content data 414 comprises selecting 420 an optimised template as described in relation to any other embodiment above.

Once representative content data has been determined for each segment, the method of any embodiment described above may further comprise rendering the representative content data so that it can be displayed to the user or other entity requesting information. Once determined, the representative content data may be displayed using any suitable user interface known in the art. For example, in some embodiments, the entity requesting information may be a html/javascript windows App. The representative content data may be displayed in HTML5 format e.g. text summary, word cloud as html word cloud, images as an album and video snippet in the default html video player. In other embodiments, any other suitable means of displaying the representative content data by transmitting it to any suitable computing device may be used.

An example of a representation 500 of a video provided by the method 100 described above is shown in FIG. 5. In this example, six video segments are shown each represented by different items of representative content data (labelled 502 to 512 in FIG. 5). As can be seen in FIG. 5, different segments of the video 502-512 are represented using items of representative content having different modalities and expanse as described above.

The present disclose also provides a corresponding data processing apparatus comprising one or more processors adapted to perform any of the computer implemented methods described herein. The data processing apparatus may be any suitable apparatus for performing each embodiment of the present disclosure or methods described in some portions of the embodiments (e.g. it may perform one or all of the method steps described in relation to the embodiments of FIGS. 1 to 4). For example, the data processing apparatus may comprise a device having one or more processors or data processing units and a memory. The memory may be any suitable computer readable media which may store instructions which when executed by the processors or data processing units cause the apparatus to perform the method of any embodiment described herein. In other embodiments, the methods of any embodiment described herein may be implemented using hardware or a mixture of hardware and software. The data processing apparatus may also comprise one or more hardware units arranged to perform any one or more of the method steps described herein. The data processing apparatus may be provided as a single apparatus or may be formed by a distributed data processing apparatus comprising a plurality of networked processors and/or data storage media.

In some embodiments, the memory may store therein one or more units each arranged to perform one or more of the method steps of any embodiment of the disclosure. For example, the memory may store a representative content data determination unit arranged to determine representative content data as described above. The representative content data determination unit may comprise an optimised template selection unit arranged to select a template using any of the method steps in any embodiment defined above. In some embodiments, the memory may include a request for information receiving module and a relevance factor determining module. The request for information receiving module may receive a request for information from any suitable entity (e.g. a search request for a user or other agent). The relevance factor determining unit may then determine a relevance factor between a segment of the video and the request for information as described above.

In some embodiments, the memory may comprise a representative content data generating module arranged to generate representative content data as described above. The representative content data generating module may comprise a decomposing module and an data item generating module arranged to decompose the video segments into one or more modalities and generate separate items of content as described above. In yet other embodiments, the memory may comprise an associating module and a storage module arranged to associate items of representative content data with a time stamp and store them accordingly.

In yet other embodiments, the memory may comprise a segment generating module arranged to generate one or more video segments as described above.

In other embodiments, the memory may comprise any one or more other modules arranged to perform the step of any of the methods described herein, and may comprise additional modules to perform further method steps if required.

The present disclosure also provides a software product. The present disclosure also provides a computer readable storage medium comprising instructions which, when executed by a computer, cause the computer to carry out the method of any embodiment or any part of any embodiment described herein. The computer readable storage media may be any suitable non-transitory computer readable storage media such as ROM/RAM, disk drive, optical disk, etc. The software product may include computer-executable instructions stored on the computer storage media that are executable by a computing device (such as a personal computer, a server or a networked device) that may implement each embodiment of the present disclosure or the methods described in some portions of the embodiments.

Modifications to the embodiments described herein will be apparent to the skilled person. The embodiments described herein are illustrative examples only. In some embodiments, the order of method steps defined may be altered or some steps omitted. Features described in relation to one embodiment may be combined with any other embodiment as would be understood by the skilled person.

1. A computer implemented method of determining representative content to be used in representing a video, the video being divided into one or more segments, each segment being associated with one or more items of representative content data for use in representing that respective segment, the one or more items of representative content data having an associated modality, the method comprising:
for each segment, selecting, based on one or more rules depending on one or more selection factors, a respective optimized template from a set comprising one or more templates, each one of the set of templates defining a different representation setting for representing the segment using its associated representative content data, the representation settings specifying the modality of representative content data to be used in representing a segment; and
determining representative content data for each of the one or more segments based on the respective optimized template for each segment.

2. The method of claim 1, wherein one or both of:
the representation settings defined by the templates specify the number of different modalities of representative content data to be used in representing a segment; and
the representation settings defined by each of the templates specify a combination of different modalities of representative content data to be used in representing a segment.

3. The method of claim 1, wherein the one or more items of representative content data have an associated expanse value, and wherein the representation settings defined by the templates indicate the expanse value of representative content data to be used in representing a segment.

4. The method of claim 1, wherein one of the selection factors is a relevance factor determined based on a current information need of an entity to which the video is to be provided, and selecting an optimised template comprises selecting a template based at least partly on the relevance factor.

5. The method of claim 1, further comprising:
receiving a request for information; and
determining the relevance factor of each of the one or more segments of the video to the request for information,
wherein the template is selected based at least partly on the relevance factor.

6. The method of claim 5, wherein the one or more items of representative content data have an associated modality, and wherein the template is selected based at least partly on a relationship between the relevance factor of the respective segment and the modality of the associated representative content data for that segment.

7. The method of claim 6, wherein the relationship comprises:
selecting a template such that the number of modalities of content specified by the template is proportional to the degree of relevance of the segment

8. The method of claim 7, wherein selecting an optimised template comprises selecting a template specifying a single modality for a segment having a first relevance factor and selecting a template specifying a mixture of modalities for another segment having a different second relevance factor,
and optionally wherein the first relevance factor indicates a lower degree of relevance of the respective segment compared to the second relevance factor.

9. The method of claim 4, wherein the one or more items of representative content data have an associated expanse value, and wherein the template is selected based at least partly on a relationship between the relevance factor of the respective segment and the expanse value of the associated representative content data for that segment.

10. The method of claim 9, wherein the relationship comprises:
selecting a template such that the expanse value of content specified by the template is proportional to the degree of relevance of the segment

11. The method of claim 10, wherein selecting an optimised template comprises:
selecting a template specifying a first expanse value for a segment having a first relevance factor and selecting a template specifying a second expanse value for another segment having a different second relevance factor, wherein optionally the first relevance factor indicates a lower degree of relevance compared to the second relevance factor, and the first expanse value indicates a lower degree of expanse compared to the second expanse value.

12. The method of claim 1, wherein one of the selection factors is a user preference defining one or more preferred properties of content for a specific user, and the template is selected based at least partly on the user preference.

13. The method of claim 12, wherein the template is selected based at least partly on a relationship between the user preference and the modality of the representative content data.

14. The method of claim 13, wherein the relationship comprises:
selecting a template having a representation setting defining a modality of the representative content data matching the user preference.

15. The method of claim 12, wherein the one or more items of representative content data have an associated expanse value, and wherein the template is selected based at least partly on a relationship between the user preference and the expanse value of the representative content data, and preferably the relationship comprises:
selecting a template having a representation setting defining an expanse of representative content data matching the user preference.

16. The method of claim 1, wherein one of the selection factors is a content availability, and wherein the template is selected based at least partly on the availability of representative content data for a segment.

17. The method of claim 16, wherein one or both of:
the one or more items of representative content data have an associated modality, and wherein selecting the template comprises selecting a template having a representation setting defining a modality of associated representative content which is available for the respective segment; and
the one or more items of representative content data have an associated expanse value and wherein selecting the template comprises selecting a template having a representation setting defining an expanse value of associated representative content which is available for the respective segment.

18. The method of claim 1, wherein any one or more of:
the template is selected from a template store comprising a plurality of predefined templates each having different representation settings;
the representative content data has one or more modalities chosen from: visual modality, paralinguistic modality, linguistic modality, video modality or supplementary information;
the method further comprises generating representative content data for each segment of the video;
the method further comprises associating the representative content data with one or more timestamps indicating a relative position within the timespan of the video;
the method further comprises storing the generated representative content data and associated timestamps in a data repository;
the method further comprises segmenting the video into the one or more segments;
the video is segmented based at least partly on a genre of the video.

19. A data processing apparatus for determining representative content to be used in representing a video, the video being divided into one or more segments, each segment being associated with one or more items of representative content data for use in representing that respective segment, the one or more items of representative content data having an associated modality, wherein the data processing apparatus comprises one or more processors, the one or more processors adapted to:
for each segment, select, based on one or more rules depending on one or more selection factors, a respective optimized template from a set comprising one or more templates, each one of the set of templates defining a different representation setting for representing the segment using its associated representative content data, the representation settings specifying the modality of representative content data to be used in representing a segment; and
determine representative content data for each of the one or more segments based on the respective optimized template for each segment.

20. A computer readable storage medium comprising instructions for determining representative content to be used in representing a video, the video being divided into one or more segments, each segment being associated with one or more items of representative content data for use in representing that respective segment, the one or more items of representative content data having an associated modality, wherein when executed by a computer, the instructions cause the computer to:
for each segment, select, based on one or more rules depending on one or more selection factors, a respective optimized template from a set comprising one or more templates, each one of the set of templates defining a different representation setting for representing the segment using its associated representative content data, the representation settings specifying the modality of representative content data to be used in representing a segment; and
determine representative content data for each of the one or more segments based on the respective optimized template for each segment.
